(19) United States
(12) Patent Application Publication
(10) Pub. No.: US 2005/0115428 A1
(43) Pub. Date: Jun. 2, 2005

(54) Strip printing unit for an automatic machine

(75) Inventors: Fiorenzo Draghetti, Medicina (IT); Davide Dall'osso, Bologna (IT)

Correspondence Address: BIRCH STEWART KOLASCH & BIRCH, PO BOX 747, FALLS CHURCH, VA, 22040-0747, US

(73) Assignee: G.D. SOCIETA' PER AZIONI, Bologna (IT)

(21) Appl. No.: 10/968,885

(22) Filed: Oct. 21, 2004

(30) Foreign Application Priority Data
Oct. 23, 2003 (IT) BO2003A000627

(51) Int. Cl. B41F 13/24

(52) U.S. Cl. 101/247; 101/484

(57) ABSTRACT

A printing unit for printing a strip on an automatic machine, wherein a pressure roller cooperates with a printing roller, having printing areas, to press the strip against the printing roller; a television camera, facing the printed surface of the strip downstream from the printing roller, optically determines the intensity of the print on the printed surface, and, depending on the intensity of the print, an actuator is activated to adjust the position of the pressure roller with respect to the printing roller.

The present invention relates to a strip printing unit for an automatic machine.

The present invention may be used to advantage in an automatic cigarette manufacturing machine, to which the following description refers purely by way of example.

### BACKGROUND OF THE INVENTION

On an automatic cigarette manufacturing machine, a strip of paper is unwound off a reel and fed to a tobacco bead forming beam where it is folded about the tobacco bead. The machine normally also comprises a printing unit located along the path of the paper strip and for printing symbols and/or writing on the strip.

Known printing units normally comprise a printing roller with printing areas on its lateral surface; a pressure roller which cooperates with the printing roller to press the paper strip against the lateral surface of the printing roller; and a number of inking rollers for depositing ink on the printing areas of the printing roller. In use, the paper strip is fed between the printing roller and the pressure roller, and is printed cyclically by the printing areas on the printing roller.

During operation of the automatic cigarette manufacturing machine, format changes are frequently necessary to change the type of cigarettes produced on the machine, and which normally also involve changing the printing areas on the lateral surface of the printing roller, or the printing roller as a whole. Once the change is made, the position of the printing roller with respect to the pressure roller must be adjusted accurately to obtain the best pressure of the pressure roller on the printing roller. With known printing units, adjusting the position of the printing roller with respect to the pressure roller is a particularly time-consuming job, in which the operator must stop the machine repeatedly to make a position change, and then start the machine up again to check the print quality. Printing roller to pressure roller position adjustments therefore call for skilled labour for a relatively prolonged period of time, during which, cigarette production is halted, thus reducing the average output of the machine.

DE 4413735 discloses a printing unit comprising a printing roller 4 (i.e. a roller designed for depositing ink on a strip 14) and a pressure roller 2; the position of the printing roller 4 is adjustable with respect to the pressure roller 2. The unit disclosed by DE 4413735 has several drawbacks: inter alia, since the printing roller is moveable, the ink feeding devices of the unit are relatively complex, as they are designed to adapt their configuration to the different positions of the printing roller 4.

### SUMMARY OF THE INVENTION

It is an object of the present invention to provide a strip printing unit for an automatic machine, designed to eliminate the aforementioned drawbacks, and which, in particular, is cheap and easy to produce.

According to the present invention, there is provided a printing unit for printing a strip on an automatic machine; the printing unit comprising a printing roller with printing areas on its lateral surface, and a pressure roller which cooperates with the printing roller to press the strip against the lateral surface of the printing roller; the printing unit being characterized by comprising a first actuator for adjusting the position of the pressure roller with respect to the printing roller; a non-contact sensor facing the printed surface of the strip, downstream from the printing roller, and for determining the intensity of the print on a printed surface of the strip; and a control unit for adjusting the position of the pressure roller with respect to the printing roller as a function of the print intensity determined by the non-contact sensor.

### BRIEF DESCRIPTION OF THE DRAWINGS

A non-limiting embodiment of the present invention will be described by way of example with reference to the accompanying drawings, in which:

FIG. 1 shows a schematic side view of a preferred embodiment of a strip printing unit in accordance with the present invention;

FIG. 2 shows a larger-scale view of part of the FIG. 1 printing unit and illustrating a servo-assisted adjusting system.

### DETAILED DESCRIPTION OF THE INVENTION

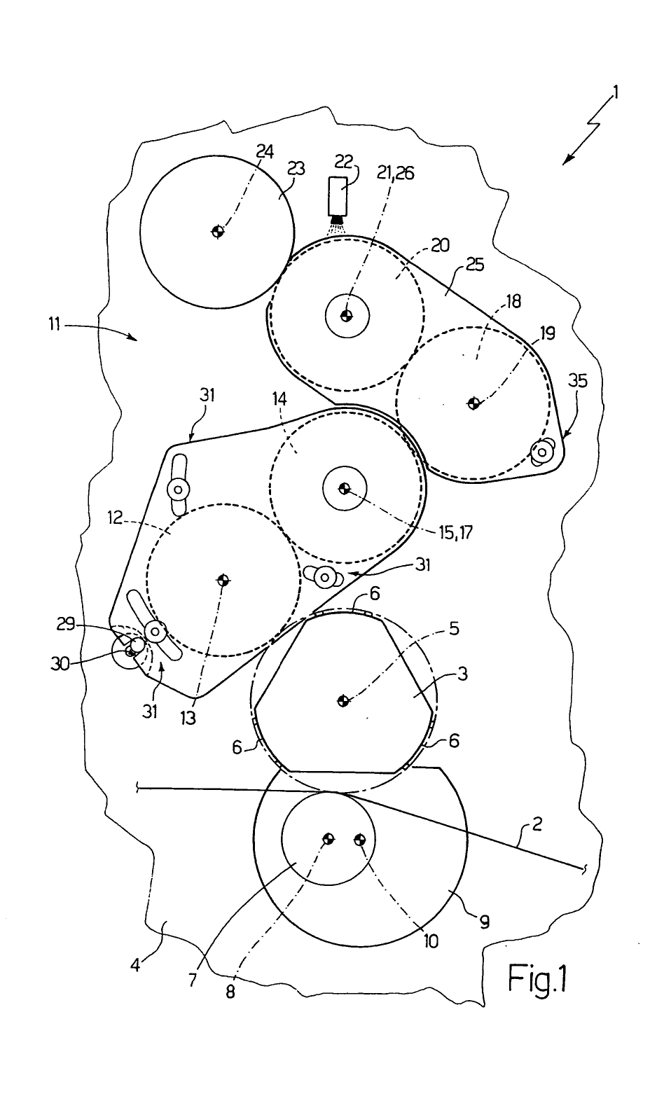

Number 1 in FIG. 1 indicates as a whole a printing unit for printing a paper strip 2 on an automatic cigarette manufacturing machine (not shown). More specifically, paper strip 2 is unwound off a reel (not shown), is fed through printing unit 1, and is then fed to a tobacco bead forming beam (not shown) where it is folded about the tobacco bead.

Printing unit 1 comprises a printing roller 3 fitted in a fixed position to a frame 4 of the automatic machine, and rotated continuously by an electric motor (not shown) about an axis 5 perpendicular to the FIG. 1 plane. Printing roller 3 has three printing areas 6 equally spaced on the lateral surface of printing roller 3, and which are pressed against strip 2 to print strip 2. A pressure roller 7 cooperates with printing roller 3, and is rotated continuously about an axis 8 parallel to axis 5 of printing roller 3 to press strip 2 against the lateral surface of printing roller 3. More specifically, pressure roller 7 is fitted in rotary manner to a frame 9, in turn fitted in rotary manner to frame 4 of the automatic machine to oscillate about an axis 10 parallel to axis 5 of printing roller 3.

Printing unit 1 also comprises an inking assembly 11 for depositing ink on printing areas 6 of printing roller 3. Inking assembly 11 comprises an inking roller 12 mounted to rotate continuously about an axis 13 parallel to axis 5 of printing roller 3, and for depositing ink on printing areas 6 of printing roller 3; and an inking roller 14 mounted to rotate continuously about an axis 15 parallel to axis 5 of printing roller 3, and for depositing ink on inking roller 12. Inking rollers 12 and 14 are fitted in rotary manner to a frame 16, in turn fitted in rotary manner to frame 4 of the automatic machine to oscillate about an axis 17 coaxial with axis 15 of inking roller 14.

Inking assembly 11 also comprises an inking roller 18 mounted to rotate continuously about an axis 19 parallel to axis 5 of printing roller 3, and for depositing ink on inking roller 14; an inking roller 20 mounted to rotate continuously about an axis 21 parallel to axis 5 of printing roller 3, and for depositing ink on inking roller 18; a sprayer 22 for depositing ink on inking roller 20; and a coating roller 23 mounted to rotate continuously about an axis 24 parallel to axis 5 of printing roller 3, and which cooperates with inking roller 20 to coat inking roller 20 with the ink sprayed by sprayer 22. Inking rollers 18 and 20 are fitted in rotary manner to a frame 25, in turn fitted in rotary manner to frame 4 of the automatic machine to oscillate about an axis 26 coaxial with axis 21 of inking roller 20.

The fact that the axis 17 of oscillation of frame 16 is coaxial with axis 15 of inking roller 14 enables frame 16 to oscillate about axis 17 to adjust the position of inking roller 12 with respect to printing roller 3 without in any way affecting the connection between inking roller 14 and inking roller 18. Similarly, the fact that the axis 26 of oscillation of frame 25 is coaxial with axis 21 of inking roller 20 enables frame 25 to oscillate about axis 26 to adjust the position of inking roller 18 with respect to inking roller 14 without in any way affecting the connection between inking roller 20 and coating roller 23.

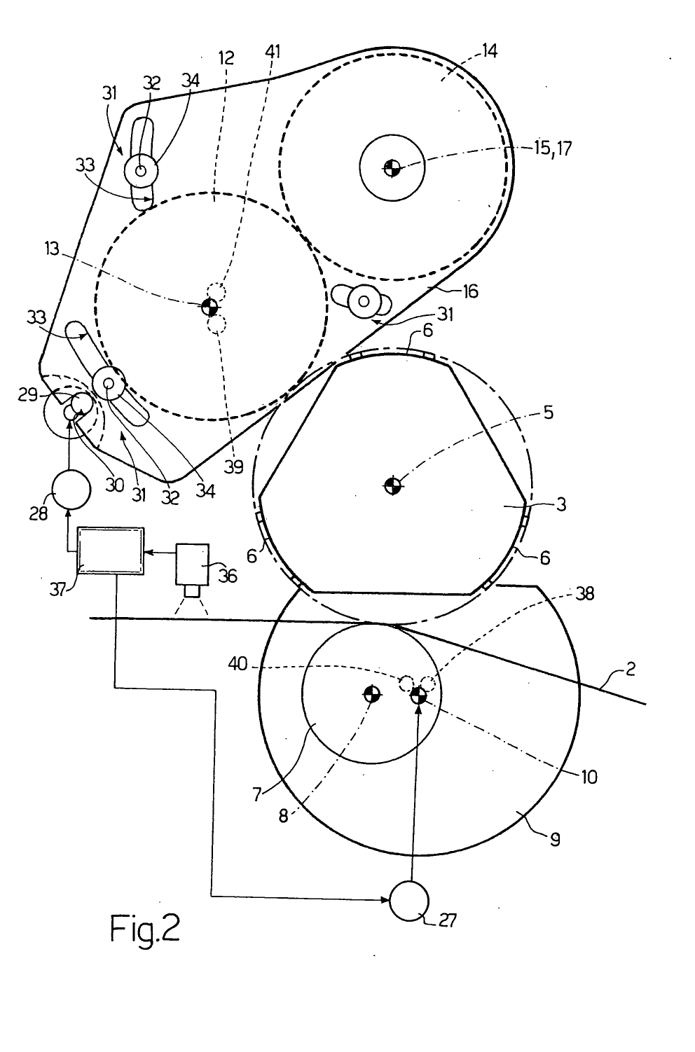

As shown in FIG. 2, an electric actuator 27 is provided to control oscillation of frame 9 about axis 10 to adjust the position of pressure roller 7 with respect to printing roller 3. More specifically, frame 9 is connected mechanically to actuator 27 by a transmission (not shown in detail) which keeps frame 9 in a fixed position when actuator 27 is idle, and which comprises a screw integral with actuator 27, and a nut screw connected to the screw and integral with frame 9.

An electric actuator 28 is also provided to control oscillation of frame 16 about axis 17 to adjust the position of inking roller 12 with respect to printing roller 3. More specifically, actuator 28 comprises an eccentric body 29 which engages a respective seat 30 formed in frame 16, and is oscillated about an axis parallel to axis 5 of printing roller 3 to adjust the position of inking roller 12 with respect to printing roller 3. To keep frame 16 in a fixed position when actuator 28 is idle, frame 16 is provided with elastic fastening members 31 which keep frame 16 pressed against frame 4 to oppose oscillation of frame 16 with a given force lower than the force generated by actuator 28. Each fastening member 31 comprises a central threaded pin 32 which is inserted inside a respective seat 33 formed in frame 16, is screwed at one end to frame 4, and at the opposite end is screwed to a knob 34 which compresses a Belleville washer (not shown) against frame 4. To keep frame 25 in a fixed position, frame 25 is provided with an elastic fastening member 35 (FIG. 1) identical with fastening members 31 described above.

Printing unit 1 also comprises a television camera 36 located downstream from printing roller 3 and facing the printed surface of paper strip 2 to pick up a real-time image of the print on paper strip 2. Camera 36 is connected to a control unit 37 which drives both actuators 27 and 28 to control both the angular position of frame 9, and therefore of pressure roller 7 with respect to printing roller 3, and the angular position of frame 16, and therefore of inking roller 12 with respect to printing roller 3.

In actual use, control unit 37, by means of camera 36, determines the intensity of the print on the printed surface of strip 2 and, accordingly, adjusts the position of pressure roller 7 with respect to printing roller 3. For example, pressure roller 7 is moved closer to printing roller 3 if the intensity of the print is below a desired value, and is moved away from printing roller 3 if the intensity of the print is above the desired value. In use, control unit 37 also adjusts the position of inking roller 12 with respect to printing roller 3 by driving actuator 28. For example, inking roller 12 is moved closer to printing roller 3 if the intensity of the print is below a desired value, and is moved away from printing roller 3 if the intensity of the print is above the desired value. In a different embodiment not shown, camera 36 is replaced with a different non-contact sensor for determining the intensity of the print on the printed surface of strip 2.

In one possible embodiment, a position sensor 38 (in particular, an angular encoder) is connected to control unit 37, and determines the angular position of frame 9 about axis 10, and therefore the position of pressure roller 7 with respect to printing roller 3. Using position sensor 38, control unit 37 is able to set a predetermined position of printing roller 3 with respect to pressure roller 7, depending on the characteristics of printing areas 6 on printing roller 3. A position sensor 39 (in particular, an angular encoder) is also connected to control unit 37, and determines the angular position of frame 16 about axis 17, and therefore the position of inking roller 12 with respect to printing roller 3. Using position sensor 39, control unit 37 is able to set a predetermined position of inking roller 12 with respect to printing roller 3, depending on the characteristics of printing areas 6 on printing roller 3. Position sensors 38 and 39 are obviously also employed by control unit 37 to feedback-control actuators 27 and 28 for adjusting the angular position of frame 9, and therefore of pressure roller 7 with respect to printing roller 3, and the angular position of frame 16, and therefore of inking roller 12 with respect to printing roller 3.

In a further embodiment, a force sensor 40 is connected to control unit 37, and determines the contact force between printing roller 3 and pressure roller 7. In actual use, control unit 37 prevents a predetermined maximum value of the contact force between printing roller 3 and pressure roller 7 from being exceeded, so as to avoid subjecting printing areas 6 to excessive mechanical stress, and so avoid damaging paper strip 2. A force sensor 41 is also connected to control unit 37, and determines the contact force between inking roller 12 and printing roller 3. In actual use, control unit 37 prevents a predetermined maximum value of the contact force between inking roller 12 and printing roller 3 from being exceeded, so as to avoid subjecting printing areas 6 to excessive mechanical stress.

Printing unit 1 as described above therefore provides for fully independently and automatically adjusting the position of pressure roller 7 and inking roller 12 with respect to printing roller 3, to achieve optimum printing quality. When making a format change, once printing roller 3 or printing areas 6 on the lateral surface of printing roller 3 have been changed, printing unit 1 need simply be started up again, and, in the space of a few seconds, is capable of independently and automatically achieving optimum printing quality, thus greatly simplifying and speeding up format changes of printing unit 1. Moreover, once the format change is completed, and before printing unit 1 is started up, the operator may inform control unit 37 of the type of printing roller 3 or printing areas 6 currently fitted to printing roller 3, so that, before printing unit 1 is started up, control unit 37 can set the initial positions of pressure roller 7 and inking roller 12 with respect to printing roller 3 on the basis of predetermined values stored in a memory of the control unit and depending on the characteristics of printing roller 3 or printing areas 6 on printing roller 3.

In a further embodiment not shown, oscillation of frame 25 about axis 26 may also be powered, like frame 16, to enable control unit 37 to also adjust the position of inking roller 18 with respect to inking roller 14.

Printing unit 1 as described above may obviously be used in any automatic machine other than an automatic cigarette manufacturing machine, such as an automatic cigarette packing machine, an automatic food packing machine, and, in general, any automatic machine involving printing strip material.

1) A printing unit for printing a strip (2) on an automatic machine; the printing unit (1) comprising a printing roller (3) with printing areas (6) on its lateral surface, and a pressure roller (7) which cooperates with the printing roller (3) to press the strip (2) against the lateral surface of the printing roller (3); the printing unit (1) being characterized by comprising a first actuator (27) for adjusting the position of the pressure roller (7) with respect to the printing roller (3); a non-contact sensor (36) facing the printed surface of the strip (2), downstream from the printing roller (3), and for determining the intensity of the print on a printed surface of the strip (2); and a control unit (37) for adjusting the position of the pressure roller (7) with respect to the printing roller (3) as a function of the print intensity determined by the non-contact sensor (36).

2) A printing unit as claimed in claim 1, wherein the non-contact sensor (36) is a television camera for optically determining the print intensity.

3) A printing unit as claimed in claim 1, wherein the pressure roller (7) is fitted in rotary manner to a first frame (9), which in turn is mounted for rotation to oscillate about a first axis (10) by virtue of the first actuator (27); the printing roller (3) being mounted for rotation about a respective fixed central axis (5).

4) A printing unit as claimed in claim 3, wherein the first frame (9) is connected mechanically to the first actuator (27) by a first transmission for maintaining the first frame (9) in a fixed position when the first actuator (27) is idle.

5) A printing unit as claimed in claim 4, wherein the first transmission comprises a screw integral with the first actuator (27); and a nut screw fitted to the screw and integral with the first frame (9).

6) A printing unit as claimed in claim 1, and comprising a first position sensor (38) connected to the control unit (37) and for determining the position of the printing roller (3) with respect to the pressure roller (7).

7) A printing unit as claimed in claim 6, wherein the control unit (37) sets a predetermined position of the printing roller (3) with respect to the pressure roller (7), depending on the characteristics of the printing areas (6) on the printing roller (3).

8) A printing unit as claimed in claim 1, and comprising a first force sensor (40) for determining the contact force between the printing roller (3) and the pressure roller (7).

9) A printing unit as claimed in claim 8, wherein the control unit (37) prevents a predetermined maximum value of the contact force between the printing roller (3) and the pressure roller (7) from being exceeded.

10) A printing unit as claimed in claim 1, and comprising a number of inking rollers (12, 14, 18, 20) for depositing ink on the printing areas (6) of the printing roller (3).

11) A printing unit as claimed in claim 10, and comprising a first inking roller (12) for depositing ink on the printing areas (6) of the printing roller (3); a second inking roller (14) for depositing ink on the first inking roller (12); and a second actuator (28) driven by the control unit (37) and for adjusting the position of the first inking roller (12) with respect to the printing roller (3).

12) A printing unit as claimed in claim 11, wherein the control unit (37) adjusts the position of the first inking roller (12) with respect to the printing roller (3) as a function of the print intensity determined by the non-contact sensor (36).

13) A printing unit as claimed in claim 11, wherein the first and second inking roller (12, 14) are fitted in rotary manner to a second frame (16), which in turn is mounted for rotation to oscillate about a second axis (17) by virtue of the second actuator (28); the printing roller (3) being mounted for rotation about a respective fixed central axis (5).

14) A printing unit as claimed in claim 13, wherein the second inking roller (14) is mounted for rotation about a respective central axis (15) coaxial with the second axis (17).

15) A printing unit as claimed in claim 13, wherein the second actuator (28) comprises an eccentric body (29), which engages a respective seat (30) formed in the second frame (16), and is oscillated to adjust the position of the first inking roller (12) with respect to the printing roller (3).

16) A printing unit as claimed in claim 15, wherein the second frame (16) has elastic fastening means (31) for opposing oscillation of the second frame (16) with a given force lower than the force generated by the second actuator (28).

17) A printing unit as claimed in claim 11, and comprising a third inking roller (18) for depositing ink on the second inking roller (14); a fourth inking roller (20) for depositing ink on the third inking roller (18); and a sprayer (22) for depositing ink on the fourth inking roller (20).

18) A printing unit as claimed in claim 11, and comprising a second position sensor (39) connected to the control unit (37) and for determining the position of the first inking roller (12) with respect to the printing roller (3).

19) A printing unit as claimed in claim 18, wherein the control unit (37) sets a predetermined position of the first inking roller (12) with respect to the printing roller (3), depending on the characteristics of the printing areas (6) on the printing roller (3).

20) A printing unit as claimed in claim 11, and comprising a second force sensor (41) for determining the contact force between the first inking roller (12) and the printing roller (3).

21) A printing unit as claimed in claim 20, wherein the control unit (37) prevents a predetermined maximum value of the contact force between the first inking roller (12) and the printing roller (3) from being exceeded.
